(19) United States
(12) Patent Application Publication
(10) Pub. No.: US 2015/0341477 A1
(43) Pub. Date: Nov. 26, 2015

(54) Device Holder

(71) Applicant: Sam Torres, Redmond, WA (US)

(72) Inventor: Sam Torres, Redmond, WA (US)

(21) Appl. No.: 14/286,988

(22) Filed: May 24, 2014

(51) Int. Cl. H04M 1/04

(52) U.S. Cl. CPC H04M 1/04

(57) ABSTRACT

The instant application discloses, among other things, a Device Holder. In one embodiment, the Device Holder may include four fasteners coupled to a device case. The fasteners may have loops attached, which may allow an elastic cord to be threaded through them, and may provide a way to attach the device to a user's arm, or chest, for example, or to another object. This may allow a user to use the device without holding it. It may also allow the device to be used more consistently, for example, for life blogging, or to have the device within reach for emergency use.

### FIELD

This disclosure relates generally to a device holder.

### BACKGROUND

Cell phones, tablets, and the like have become part of many people's lifestyle.

### SUMMARY

The instant application discloses, among other things, a Device Holder. In one embodiment, the Device Holder may include four fasteners coupled to a device case. The fasteners may have loops attached, which may allow an elastic cord to be threaded through them, and may provide a way to attach the device to a user's arm, or chest, for example, or to another object. This may allow a user to use the device without holding it. It may also allow the device to be used more consistently, for example, for life blogging, or to have the device within reach for emergency use. One having skill in the art will recognize that there may be many uses for a flexible securing system provided by a Device Strap.

### BRIEF DESCRIPTION OF THE DRAWINGS

FIG. 1 is a view of a Device Holder, according to one embodiment.

FIG. 2 is a view of a corner of a case, according to one embodiment.

FIG. 3 illustrates a user using Device Holder with a lanyard, according to one embodiment.

FIG. 4 illustrates yet another embodiment using additional elastic cords.

### DETAILED DESCRIPTION

A more particular description of certain embodiments of Device Holder may be had by references to the embodiments shown in the drawings that form a part of this specification, in which like numerals represent like objects.

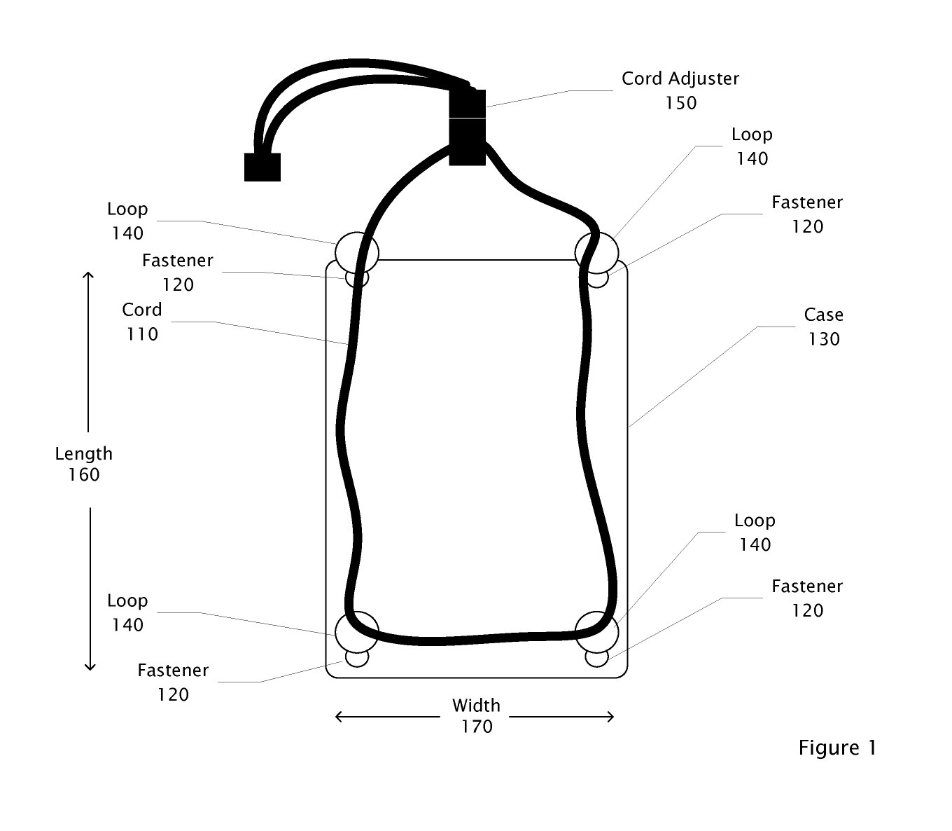

FIG. 1 is a view of a Device Holder, according to one embodiment. In this example, Cord 110 may include Fasteners 120 coupled to Case 130. Cord 130 may be coupled to Case 130 by Loops 140. Cord Adjuster 150 may be used to adjust an effective length of Cord 110, which may allow a user to increase or decrease tension.

In this example, Case 130 may hold a smartphone or other device. A user may insert two fingers snugly between Cord 110 and Case 130 perpendicular to the Length 160 direction or perpendicular to the Width 170 direction, enabling holding the device with one hand. This may be used, for example, to hold the device high to take pictures at a concert.

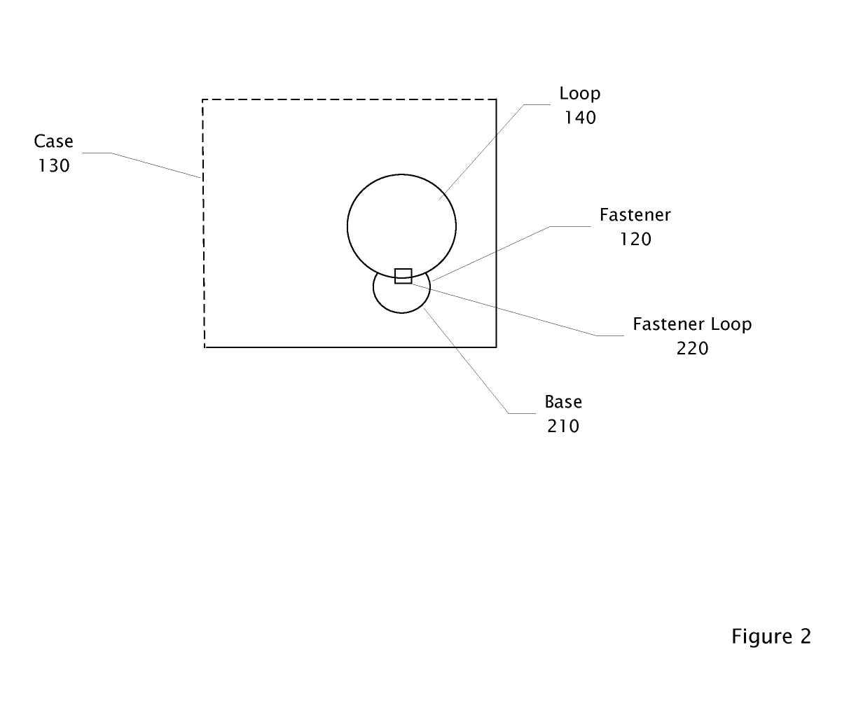

FIG. 2 is a view of a corner of Case 130, showing Fastener 120. Fastener 120 may have a Base 210. Fastener Loop 220 may be made of metal, and may pass through a hole in Case 130, with Base 210 remaining inside Case 120, and Fastener Loop 220 exposed on another side, which may allow Loop 140 to couple with Fastener Loop 220, preventing Fastener 120 from uncoupling with Case 130. Loop 140 may be used to attach Cord 110.

In another embodiment, Fastener 120 may be similar to a Command™ Clear Decorating Clip, which may couple to Case 130 with an adhesive. One having skill in the art will recognize that many different techniques and materials may be used to provide a means for coupling Cord 110 to Case 130.

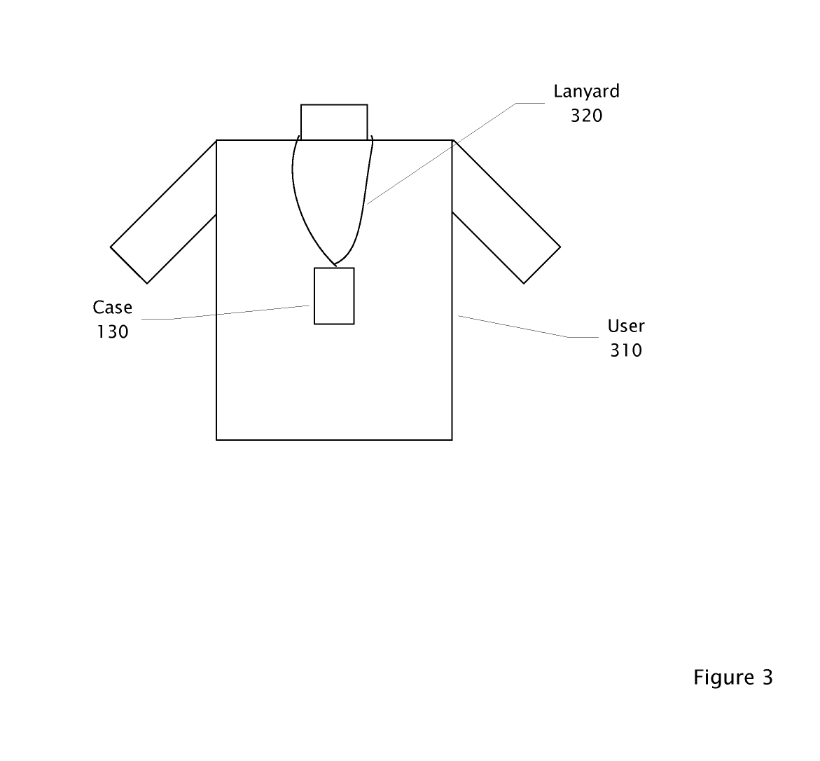

FIG. 3 illustrates a user using Device Holder with a lanyard, according to one embodiment. In this embodiment, an additional cord, such as a Lanyard 320, may be coupled to Cord 110, which may allow User 310 to keep the device within easy reach without requiring the user to hold the device constantly.

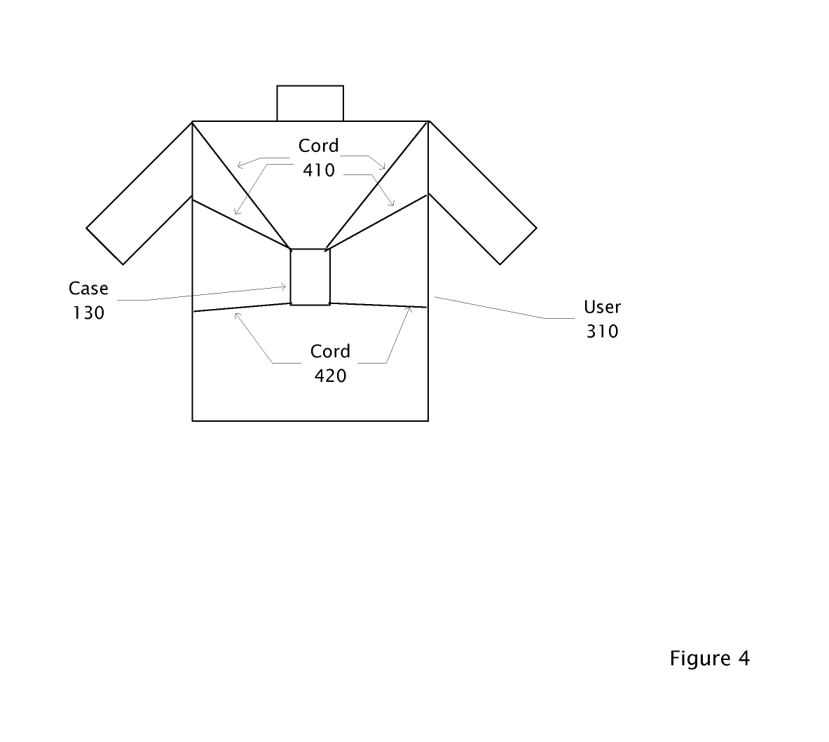

FIG. 4 illustrates yet another embodiment using additional elastic Cords 410 and 420. Cord 410 may be coupled to Cord 110 near two corners of a top of Case 130. Cord 410 may be stretched around a user's arms, which may hold Case 130 in place. Cord 420 may be coupled to Cord 110 near two corners on a bottom of Case 130. With four attachment points, Case 130 may hold Case 130 in position tightly enough to be used for life blogging or other similarly demanding activities.

In other embodiments, a user may use a cord around a waist to hold Case 130 in a convenient place. A lanyard-type cord may be slung over a shoulder to hold a device on a user's side. Cord 110 may be placed around a post for stability during a video recording. One having skill in the art will recognize that many different configurations of attaching a Case 130 to a user or other objects may be available using Device Holder.

While the detailed description above has been expressed in terms of specific examples, those skilled in the art will appreciate that many other configurations could be used.

Accordingly, it will be appreciated that various equivalent modifications of the above-described embodiments may be made without departing from the spirit and scope of the invention.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A device holder, comprising:
a case configured to fit a device;
a plurality of fasteners coupled to the case, the fasteners incorporating a loop to couple to a cord; and
a first cord, coupled to the plurality of fasteners.

2. The device holder of claim 1, wherein there are four fasteners.

3. The device holder of claim 1, wherein the first cord is an elastic cord.

4. The device holder of claim 3, further comprising a cord adjuster.

5. The device holder of claim 4, wherein the first cord is adjusted to fit snugly over two fingers inserted between the first cord and the case.

6. The device holder of claim 3, further comprising a lanyard.

7. The device holder of claim 3, further comprising a second cord, the second cord coupled to the first cord.
